(19) United States
(12) Patent Application Publication
(10) Pub. No.: US 2003/0074437 A1
(43) Pub. Date: Apr. 17, 2003

(54) Method, computer program, data carrier and data processing device for configuring a firewall or a router

(76) Inventors: Gerald Exenberger, Bubenreuth (DE); Stephan Welsing, Hochstadt (DE)

Correspondence Address: YOUNG & THOMPSON, 745 SOUTH 23RD STREET 2ND FLOOR, ARLINGTON, VA, 22202

(21) Appl. No.: 10/247,566

(22) Filed: Sep. 20, 2002

(30) Foreign Application Priority Data
Sep. 20, 2001 (DE) 101 46 397.9

(51) Int. Cl. G06F 15/173

(52) U.S. Cl. 709/223; 713/201

(57) ABSTRACT

A method for configuring a firewall or a router, a first computer or a first computer network being connected to a second computer network via the firewall or the router, and the router or the firewall being configured in such a way that a computer communication between a computer of the second computer network and the first computer or a predefined computer of the first computer network is made possible. For the configuration it is necessary to fill out a respective application form which is then automatically translated into a code which is suitable for the configuration. The invention also relates to a computer program which implements this translation, a data carrier on which the computer program is stored, and a data processing device on which the computer program is installed.

### FIELD OF THE INVENTION

The invention relates to a method, a computer program, a data carrier and a data processing device for configuring a firewall or a router.

### BACKGROUND OF THE INVENTION

The main function of a firewall is to protect a local computer network, which may be for example an Intranet of an industrial company, against attack from an external computer network, for example the Internet. An attack is for example an attempt by a person referred to as a hacker to access the Intranet from the Internet without authorization in order, for example, to obtain data from the Intranet without authorization or to place in what is referred to as a computer virus on the Intranet. In order to protect against the attack, the firewall prevents any communication between the integral computers of the local computer network and computers of the external computer network. A firewall can be connected, for example, between the local computer network and the external computer network so that access to the local computer network from the external computer network is permitted only to specific users who are predefined on the basis of a configuration of the firewall. This is necessary, for example in what is referred to as a partner connection in which computers of various computer networks communicate with one another, in a home workstation or in an external service connection via modem or ISDN (Integrated Service Digital Network). The firewall can, however, also be configured in such a way that only specific users of the local computer network can communicate with computers of the external computer network. However, a firewall can also prevent direct communication between an individual computer and a computer network (cf. for example Stefan Strobel “Firewalls”, second updated and expanded edition, Heidelberg, dpunkt-Verlag, 1999, or “Computer-Fachlexikon” [Computer specialist dictionary], Microsoft Press Deutschland, Unterschleiβheim, 2000, page 282).

A router is a switching device in a computer network, which ensures the most efficient possible transmission of data from one computer to another computer of the computer network, for example on the basis of a protocol which is assigned to a data record transmitted from one computer to the other computer and which may be, for example, what is referred to as an Internet protocol (IP). A router can also connect different computer networks to one another, for example the local computer network and the external computer network. A router can also be configured in such a way that it also has a firewall functionality. This is possible, for example, if what is referred to as an IP filter is implemented by means of the router. A router with an IP filter then passes on only data records of a predetermined type, with predetermined source addresses and/or target addresses, predetermined source ports and/or target ports or even possibly data records with predetermined flags.

Before the user can access specific computer programs of the local computer network from, for example, a computer of the external computer network, the fire-wall or the router must be configured in a suitable way. This is generally done by a specially trained person known as an administrator who is also responsible for smooth operation of the local computer network. Before the administrator suitably configures the firewall or the router, the user generally makes an application to be allowed to access the desired computer program. The administrator then checks whether the user is at all allowed to access the computer program referred to by him, and subsequently carries out a technical risk analysis which is intended to at least limit possible security risks. The intention is, for example, to ensure, on the basis of the technical risk analysis, that the user has access only to the computer program desired by him, or that an unauthorized person has access to a computer program or a computer of the local computer network on the basis of a negligently executed technical risk analysis. On the basis of the technical risk analysis, the administrator determines, for example, suitable IP filter or port filters or else suitable host routing. The administrator then configures the firewall or the router in a suitable way so that the user can access the computer program desired by him.

However, this process may be relatively time-consuming and can generally be carried out only by a specialist such as the administrator.

### SUMMARY OF THE INVENTION

The object of the invention is therefore to specify a method which provides a precondition for configuring a firewall or a router in a simple and, in particular, timesaving fashion.

The object is achieved by means of a method for configuring a firewall or a router, a first computer or a first computer network being connected to a second computer network via the firewall or the router, and the router or the firewall being configured in such a way that a computer communication between a computer of the second computer network and the first computer or a predefined computer of the first computer network is made possible, having the following method steps:

a prepared application form which is assigned to the computer communication is filled out, and

the filled-out application form is automatically translated into a code which is suitable for the configuration of the firewall or of the router.

According to the invention, a prepared application form which is assigned to the computer communication is therefore filled out before the configuration. Assigned to the computer communication is understood to mean that the application form is used to provide information which is necessary for the desired computer communication. This information comprises, for example, a target address or an ISDN number of that computer with which communication is to be carried out, a possible authentication scheme, for example CHAP (Challenge Handshake Authentication Protocol), VPNs (virtual private network) etc. Further, the intention is that it will not be possible to use the application form to provide any information which can be used to configure the firewall or the router differently from the desired computer communication. The method according to the invention may, for example, provide a particular saving in time for the configuration if different users desire access to the same computer program or computer. Then, in fact large parts of the technical risk analysis have to be carried out only once as a large number of settings, in particular IP filters or port filters for the various users are the same or at least similar. Consequently, for one preferred variant of the invention there is provision for the application form to be based on a technical risk analysis which is generated once and assigned to the computer communication.

After the application form has been filled out, according to the invention the application form is automatically translated into the code which is suitable for configuring the firewall or the router. The translation is preferably carried out automatically by means of a suitable computer program. In this way, manual translation of the application form by the administrator is avoided. Instead, as is provided according to a further embodiment of the invention, the firewall or the router can be automatically configured after the translation into the code.

The main advantage of the method according to the invention is thus that only one application form which is assigned to the computer communication has to be filled out when the firewall or the router is configured. The translation into the code, and possibly the configuration are then carried out automatically. This results not only in a saving in time with respect to the configuration of the firewall or the router but also in a reliable configuration of the firewall or of the router as no manual steps which are possibly subject to errors are necessary between the filling out of the application form and the configuration. In addition, the technical risk analysis only has to be carried out once.

According to one variant of the invention, after the automatic configuration of the firewall or of the router, an administrator who maintains the first computer network or the first computer is automatically informed of the configuration. The administrator of the first computer network or of the first computer, that is to say the person who is responsible for the smooth operation of the first computer network or of the first computer is thus reliably informed of a modified configuration of the firewall or of the router.

According to embodiments of the invention, the first and/or the second computer network is an Intranet, an ISDN network, (Integrated Service Digital Network) or the Internet.

As already described above, the application form is advantageously translated into the code by means of a computer program. According to further advantageous variants of the invention, the computer program is stored on a data carrier or installed on a data processing device.

### BRIEF DESCRIPTION OF THE DRAWINGS

An exemplary embodiment is illustrated in exemplary form in the schematic drawings, in which:

FIG. 1 shows a situation which illustrates the method according to the invention,

FIG. 2 shows a flowchart which illustrates the method according to the invention, and

FIG. 3 shows an application form.

### DETAILED DESCRIPTION OF THE INVENTION

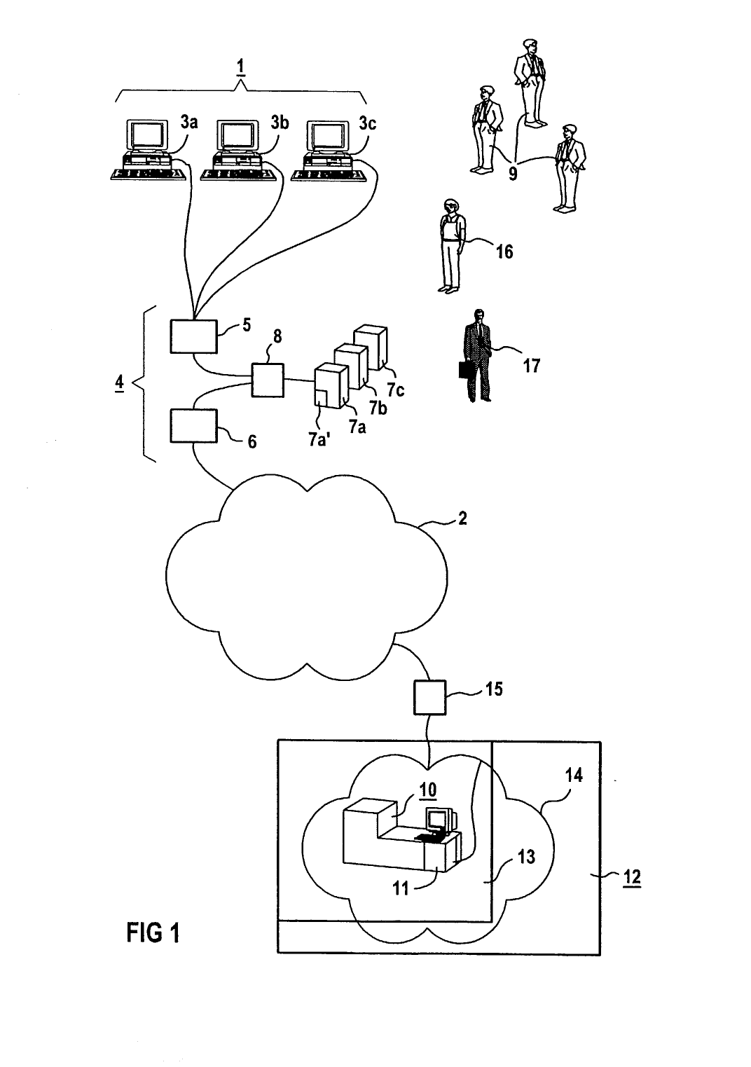

FIG. 1 shows a typical structure of a connection of a local computer network, which in the present exemplary embodiment is an Intranet 1 of an industrial company which manufactures medical equipment, to an external network. In the present exemplary embodiment, the external network is an ISDN network (Integrated Service Digital Network) 2. Such a structure is presented in principle, for example in Stefan Strobel “Firewalls”, second updated and expanded edition, Heidelberg, dpunkt-Verlag, 1999 on page 210.

In the present exemplary embodiment, the Intranet 1 comprises a plurality of PCs, of which PCs 3a to 3c are illustrated by way of example in FIG. 1. The individual PCs 3a to 3c are connected to one another in a way which is generally known to the person skilled in the art, for example by means of a BUS which is not illustrated in FIG. 1.

In order to prevent direct data traffic between the PCs 3a to 3c or the Intranet 1 and the ISDN network 2, in order thus to minimize, for example, data traffic, which is costly under certain circumstances, from the Intranet 1 to the ISDN network 2 or to limit or monitor-access from the ISDN network 2 into the Intranet 1, the PCs 3a to 3c of the Intranet 1 can communicate with the ISDN network 2 only via what is referred to as a demilitarized zone (DMZ) 4. The DMZ 4, which is also referred to as a firewall network, comprises, in the present exemplary embodiment, an inner router 5, an outer router 6 and a plurality of servers, of which servers 7a to 7c are illustrated in FIG. 1 by way of example.

The inner router 5 is connected here to the Intranet 1 and permits communication between the individual computers 3a to 3c and the servers 7a to 7c. The outer router 6 is, on the other hand, connected to the ISDN network 2 and permits only a communication between individual computers connected to the ISDN network 2 and the servers 7a to 7c. There is thus no direct connection between the ISDN network 2 and the Intranet 1. Instead, the PCs 3a to 3c can only communicate via the servers 7a to 7c with the computers connected to the ISDN network 2. In order to obtain additional protection of the Intranet 1 and of the servers 7a to 7c, the servers 7a to 7c are additionally protected with a firewall 8 which is connected between the inner router 5, the outer router 6 and the servers 7a to 7c.

The inner router 5 and the firewall 8 are configured in the present exemplary embodiment in such a way that employees 9 of the industrial company have access, by means of the PCs 3a to 3c, to data, computer programs, applications etc. specific to them and stored in the servers 7a to 7c of the DMZ 4. On the other hand, the outer router 6 is configured, in conjunction with the firewall 8, in such a way that only specific computer programs, files, applications etc. stored in the servers 7a to 7c are accessible from the ISDN network 2. The communication between one of the employees 9 using one of the PCs 3a to 3c and a computer which is connected to the ISDN network 2 is therefore possible only via the DMZ 4, and in particular only via one of the servers 7a to 7c.

As already mentioned, in the present exemplary embodiment, the industrial company manufactures medical equipment, for example a magnetic resonance device 10 illustrated in FIG. 1. In the present exemplary embodiment, the magnetic resonance device 10 has been sold to a hospital 12 and is located in an examination room 13 of the hospital 12.

In the present exemplary embodiment, the magnetic resonance device 10 comprises a computer 11 which controls, inter alia, the magnetic resonance device 10 suitably during operation, in a way which is known to the person skilled in the art. The computer 11 of the magnetic resonance device 10 is also connected to a local computer network (hospital network) 14 of the hospital 12, the hospital network 14 being in turn connected to the ISDN network 2 by means of a router 15.

In the present exemplary embodiment, a service computer program, which is suitable inter alia for remote maintenance of the magnetic resonance device 10, is also stored in the server 7a of the DMZ 4. By means of this service program, a technician 16 of the industrial company can test the magnetic resonance device 10 remotely in a way with which the person skilled in the art is familiar if the inner router 5, the outer router 6, the firewall 8 and the router 15 are suitably configured. The technician 16 can therefore use one of the PCs 3a to 3c to access the service computer program stored in the server 7a and communicate with the computer 11 of the magnetic resonance device 10.

In the present exemplary embodiment, the technician 16 is responsible for performing remote maintenance on magnetic resonance devices which are sold by the industrial company, for which reason the inner router 5 and the firewall 8 have already been configured in such a way that the technician 16 can use one of the PCs 3a to 3c to access the service computer program stored in the server 7a; the firewall 8 is also already configured in such a way that the transmission and reception of data records assigned to the service computer program to and from the ISDN network 2 is made possible as, in the present exemplary embodiment, the technician 16 already performs remote maintenance on other magnetic resonance devices using one of the PCs 3a to 3c, said magnetic resonance devices not being illustrated in FIG. 1 and being comparable to the magnetic resonance device 10. Only the outer router 6 therefore then needs to be configured in such a way that remote maintenance of the magnetic resonance device 10 is made possible. The router 15 has moreover already been suitably configured by an employee (not illustrated in FIG. 1) of the hospital 12.

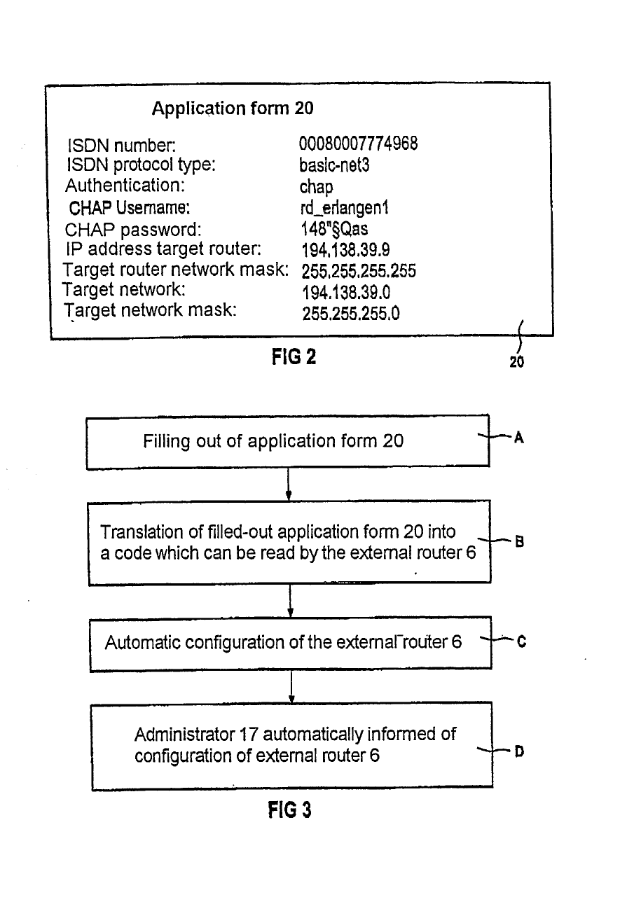

For this reason, in the present exemplary embodiment the technician 16 uses one of the PCs 3a to 3c, in the present exemplary embodiment PC 3a, to call an application form 20 which is stored in one of the servers 7a to 7c, shown in FIG. 2, and appears on a monitor of the PC 3a after the technician 16 has verified his access authorization by inputting a password assigned to him. The application form 20 illustrated in FIG. 2 is provided for configuring the outer router 6 in such a way that the computer which is connected to the ISDN network 2 can communicate with the server 7a by means of the service computer program. Since the application form 20 is already assigned to the service computer program, information which the server 7a to 7c is intended to access is unnecessary. The application form 20 comprises essentially only information relating to the desired target computer. The application form 20 therefore does not permit any information which permits access to a server other than the server 7a of the DMZ 4 or some other service computer program stored on the server 7a. The application form 20 has also been produced on the basis of a technical risk analysis which has been carried out once and is already represented as having been filled out.

After the technician 16 has loaded the application form 20 on the PC 3a, he fills it out (step A of the flowchart represented in FIG. 3):

In the present exemplary embodiment, the technician is requested, by means of the application form 20, to specify the ISDN number of that computer with which it wishes to communicate and to specify the respective ISDN network. The technician 16 must also give details on the type of network (ISDN protocol type), that is to say whether it is, for example, the European ISDN network. In addition, details are required on a CHAP (Challenge Authentication Protocol), user name, a CHAP password, the IP address of the target router, the target router net mask, the target network and the target network mask.

In the present exemplary embodiment, the technician 16 would like to communicate with the computer 11 of the magnetic resonance device 10, for which reason he fills out the application form 20 in an appropriate way with the ISDN number of the computer 11. In addition, the computer 11 is connected by means of the router 15 to the hospital network 14 so that the technician 16 specifies the IP address of the router 15 and code assigned to the hospital network 14.

After the technician 16 has filled out the application form 20, he transmits the filled-out application form to the server 7a. The server 7a comprises, in the present exemplary embodiment, a hard disk 7a′ in which a suitable computer program is stored and, after the server 7a has received the filled-out application form 20, said computer program automatically translates the information of the filled-out application form 20 into a code which can be read by the outer router 6 (step B in the flowchart illustrated in FIG. 3). This code is as follows in the present exemplary embodiment, only relevant commands being specified:

... .

...... .

dialer map ip 194.138.39.9 name rd_erlangen1 00080007774968

isdn switch-type basic-net3

ppp authentication chap

username rd_erlangen1 password 148″§Qas

ip route 194.138.39.0 255.255.255.0 194.138.39.9

ip route 194.138.39.9 255.255.255.255 BRI0

... . .

. .

Then, in the present exemplary embodiment, the computer program automatically configures the outer router 6 on the basis of the code just mentioned so that the technician 16 can perform maintenance on the magnetic resonance device 10 with one of the PCs 3a to 3c (step C of the flowchart illustrated in FIG. 3).

After the configuration of the outer router 6, in the present exemplary embodiment the computer program automatically generates an e-mail in order to inform an administrator 17 who is responsible for the Intranet 1 of the configuration of the outer router 6 (step D of the flowchart illustrated in FIG. 3).

In addition to configuring the outer router 6 by means of the application form 20, further application forms which can be used to configure automatically the inner router 5 or the firewall 8 are stored in the server 7a or the server 7b or 7c.

However, automatic configuration of the outer router 6 after the automatic translation of the filled-out application form 20 into the code is optional for the method according to the invention. Informing the administrator 17 of the configuration of the outer router 6 is also optional.

The computer networks illustrated in FIG. 1 are also only of an exemplary nature.

1. A method for configuring a firewall or a router, a first computer or a first computer network being connected to a second computer network via the firewall or the router, and the router or the firewall being configured in such a way that a computer communication between a computer of the second computer network and the first computer or a predefined computer of the first computer network is made possible, the method comprising:
filling out a prepared application form which is assigned to the computer communication; and
automatically translating the filled-out application form into a code which is suitable for the configuration of the firewall or of the router.

2. The method as claimed in claim 1, in which the application form is based on a technical risk analysis which is generated once and assigned to the computer communication.

3. The method as claimed in claim 1, in which, after the automatic translation of the filled-out application form into the suitable code, the firewall or the router is automatically configured.

4. The method as claimed in claim 3, in which, after the automatic configuration of the firewall or of the router, an administrator who maintains the first computer network or the first computer is informed of the configuration.

5. The method as claimed in claim 1, in which the first computer network is an Intranet, an ISDN network (Int Service Digital Network) or the Internet.

6. The method as claimed in claim 1, in which the second computer network is an Intranet, an ISDN network (Integrated Service Digital Network) or the Internet.

7. A computer program which implements translation of the application form as claimed in claim 1.

8. A data carrier on which the computer program as claimed in claim 7 is stored.

9. A data processing device on which the computer program as claimed in claim 7 is installed.

10. The method as claimed in claim 2, in which, after the automatic translation of the filled-out application form into the suitable code, the firewall or the router is automatically configured.

11. The method as claimed in claim 10, in which, after the automatic configuration of the firewall or of the router, an administrator who maintains the first computer network or the first computer is informed of the configuration.

12. The method as claimed in claim 2, in which the first computer network is an Intranet, an ISDN network (Int Service Digital Network) or the Internet.

13. The method as claimed in claim 3, in which the first computer network is an Intranet, an ISDN network (Int Service Digital Network) or the Internet.

14. The method as claimed in claim 4, in which the first computer network is an Intranet, an ISDN network (Int Service Digital Network) or the Internet.

15. The method as claimed in claim 10, in which the first computer network is an Intranet, an ISDN network (Int Service Digital Network) or the Internet.

16. The method as claimed in claim 11, in which the first computer network is an Intranet, an ISDN network (Int Service Digital Network) or the Internet.

17. The method as claimed in claim 2, in which the second computer network is an Intranet, an ISDN network (Integrated Service Digital Network) or the Internet.

18. The method as claimed in claim 3, in which the second computer network is an Intranet, an ISDN network (Integrated Service Digital Network) or the Internet.

19. The method as claimed in claim 4, in which the second computer network is an Intranet, an ISDN network (Integrated Service Digital Network) or the Internet.

20. The method as claimed in claim 5, in which the second computer network is an Intranet, an ISDN network (Integrated Service Digital Network) or the Internet.
